(19) United States
(12) Patent Application Publication
(10) Pub. No.: US 2010/0320741 A1
(43) Pub. Date: Dec. 23, 2010

(54) Notebook

(76) Inventor: Jian TAO, Shen Zhen City (CN)

Correspondence Address: Jackson Intellectual Property Group PLLC, 106 Starvale Lane, Shipman, VA, 22971, US

(21) Appl. No.: 12/487,732

(22) Filed: Jun. 19, 2009

(51) Int. Cl. B42D 3/00

(52) U.S. Cl. 281/29

(57) ABSTRACT

A notebook of the present invention comprises a main body, and a cover. The main body includes a plurality of pages with four corners thereof being round. The cover covers the main body with round corners corresponding to the four round corners of the main body. The width of the notebook from left to right is larger than the length of the notebook from up to down. The notebook of the present invention can protect the corners thereof from curling, deforming, or damaging during contact with other objects. Not only the notebook is kept a clean appearance, but also the service life of the notebook can be increased at a certain extent The notebook is convenient to use through flipping upwards and making the proportion between the width and the length greater than 1.

### FIELD OF THE INVENTION

The present invention relates to a notebook, particularly relates to a notebook with four round corners.

### BACKGROUND OF THE INVENTION

A notebook is generally rectangular with two corners of the moveable part, and two corners of the fixed part. While being used, the four corners of ninety degrees of the conventional notebook are easily deformed or curled due to contact with other objects. Therefore, after being used for a period of time, the notebooks are readily deformed or damaged at the corners thereof.

To encounter the above problem, the two corners of the moveable part of the conventional notebook are made round to reduce the abrasion. The two corners of the fixed part of the notebooks are never made round for a long time, since it is generally thought that the two corner of the fixed part will not meet the problem of being deformed by flipping or touching. However, after the notebooks are used for a long time, it will appear that the corners of the fixed part are deformed or damaged, since the notebooks are often carried in bags. During the course of being carried and used, the problem will occur that the corners of the fixed part are deformed or curled for being touched. So, it becomes very necessary to overcome the prejudice in designing a notebook, and to solve the problem that exists for a long time in this industry. It is more urgent to solve this problem, particularly for those notebooks having covers made from comparatively hard materials.

Moreover, conventional notebooks all adopt the size in which the width from left to right is smaller than the length from up to down. Generally the proportion between the width and the length of a conventional notebook is 3:4. With this proportion between the width and the length, if a notebook is flipped upwards about a top edge thereof, the notebook will occupy a large space while being used. So, a conventional notebook with covers generally is flipped sideward about a left edge thereof. However, after a page is flipped sideward, the back of the page usually leans along a direction of writing due to the thickness of a notebook, which results in inconvenience of writing or even nonuse of the back of the page. Therefore, the notebook flippable sideward may result in waste of resources. A notebook flippable upwards can solve the problem that a page will lean along the writing direction after it is flipped. Thus, if the prejudice in techniques can be overcome to change the conventional proportion between the width and the length of the notebook, a better notebook can be provided to flip upwards.

### SUMMARY OF THE INVENTION

An object of the present invention is to provide a notebook which has four round corners for preventing from deforming or curling during contact with other objects, so as to increase the service life of the notebook.

Another object of the present invention is to provide a notebook which has a cover made from materials with metal tactile sensation and has four round corners thereby increasing the service life of the notebook.

A further object of the present invention is to provide a notebook, which is flappable upwards about a top edge thereof with the width thereof being larger than the length thereof thereby facilitating to use.

To achieve the above mentioned objects, a notebook of the present invention comprises a main body, and a cover. The main body includes a plurality of pages with four corners thereof being round. The cover covers the main body with round corners corresponding to the four round corners of the main body.

Wherein the cover comprises a front cover, a back cover, and a connecting part connected between the front cover and the back cover, and the four corners of the front cover and the back cover are round respectively corresponding to the four round corners of the main body.

Wherein each end of the connecting part, the front cover, and the back cover cooperatively form a U-shaped groove.

Wherein an L-shaped fastening part extends from the middle of the side of the back cover apart from the connecting part for being fastened to the front cover.

Wherein the free end of the fastening part is provided with a magnet, and the fastening part is rotatablely attached to the front cover; the front cover is provided with a magnet corresponding to the magnet at the free end of the fastening part.

Wherein the cover is made from materials with metal tactile sensation.

Wherein the cover is made from an aluminum foil paper, or an aluminium plating film.

Wherein the notebook is flippable upwards.

Wherein the width of the notebook from left to right is larger than the length of the notebook from up to down.

Wherein the proportion of the notebook between the width thereof and the length thereof is from 4:3 to 16:9.

The notebook of the present invention can protect the corners thereof from curling deforming, or damaging during contact with other objects. Not only the notebook is kept a clean appearance, but also the service life of the notebook can be increased at a certain extent. The notebook is convenient to use through flipping upwards and making the proportion between the width and the length greater than 1.

The characteristic and the technical solution of the present invention are best understood from the following detailed description with reference to the accompanying figures, but the figures are only for reference and explaining, not to limit the scope of the invention.

### BRIEF DESCRIPTION OF THE DRAWINGS

The technical solution and the beneficial effects of the present invention are best understood from the following detailed description with reference to the accompanying figures and embodiments.

FIG. 1 is an exploded view of a notebook of the present invention;

FIG. 2 is an assembled view of FIG. 1;

FIG. 3 is a perspective view showing the notebook of the present invention being close.

### DESCRIPTION OF THE PREFERRED EMBODIMENT

To further set forth the technical solution adopted by the present invention and the effect, the present invention is described detailedly with reference to the preferred embodiments and the accompanying figures.

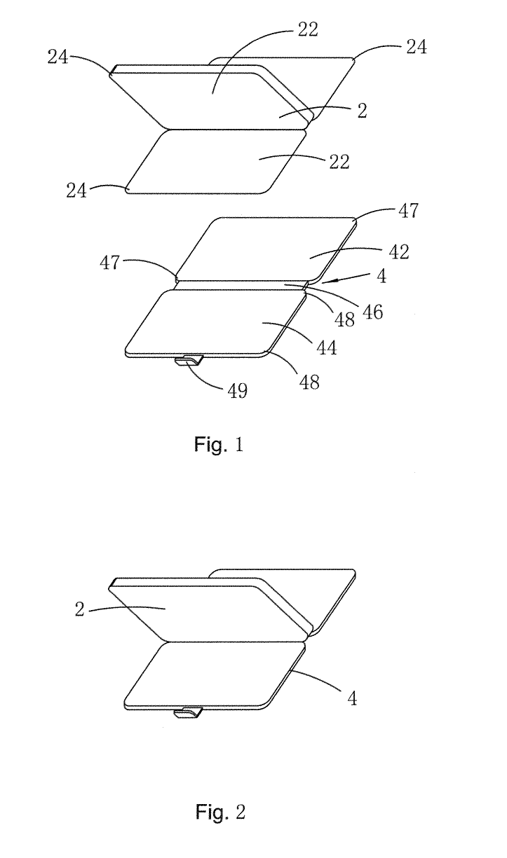

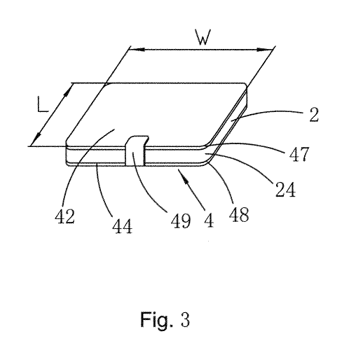

Referring to from FIG. 1 to FIG. 3, a notebook of the present invention comprises a main body 2, and a cover 4 attached to the main body 2. The main body 2 includes a plurality of pages 22 with four corners 24 thereof being round.

The cover 4 is slightly larger than the main body 2 to cover the main body 2. The cover is provided with round corners corresponding to the four corners 24 of the main body 2. The cover 4 comprises a front cover 42, a back cover 44, and a connecting part 46 connected between the front cover 42 and the back cover 44. The four corners 47, 48 of the front and back covers 42, 44 are round respectively corresponding to the four round corners 24 of the main body 2. Each end of the connecting part 46, the front cover 42, and the back cover 44 cooperatively form a U-shaped groove (not labeled). The cover 4 is made from materials with metal tactile sensation, such as an aluminum foil paper, an aluminium plating film and so on, which increases aesthetic sensibility, durability, and novelty of the notebook.

The four corners of the notebook of the present invention are round for preventing the covers or pages from being curled, deformed, or damaged during contact with other objects, thereby not only keeping the appearance of the notebook clean, but also increasing the service life of the notebook. The four round corners of the cover prevent the cover made of comparatively hard materials with metal tactile sensation from scratching the user or other objects.

The notebook of the present invention is flappable upwards with the width W from left to right being larger than the length L from up to down, which increases convenience of writing and reduces the space occupied by the notebook during use. The preferred proportion between the width W and the length L is from 4:3 to 16:9.

An L-shaped fastening part 49 extends from the middle of the side of the back cover 44 apart from the connecting part 46 for being fastened to the front cover 42. The free end of the fastening part 49 is provided with a magnet (not shown). A magnet (not shown) is disposed at the front cover 42 corresponding to the magnet at the free end of the fastening part 49. Thus the fastening part 49 can be attracted to the front cover 42 by the magnetic force. The fastening part 49 is rotatablely attached to the front cover 42. Therefore, the notebook of the present invention is easier to carry, and keep the main body 2 clean.

In summary, the notebook of the present invention can protect the corners thereof from curling, deforming, or damaging during contact with other objects. Not only the notebook is kept a clean appearance, but also the service life of the notebook can be increased at a certain extent. The notebook is convenient to use through flipping upwards and making the proportion between the width and the length greater than 1.

Although the present invention has been described in detail with above said embodiments, but it is not to limit the scope of the invention. So, all the modifications and changes according to the characteristic and spirit of the present invention, are involved in the protected scope of the invention.

What is claimed is:

1. A notebook comprising:
a main body including a plurality of pages with four corners thereof being round; and
a cover covering the main body with round corners corresponding to the four round corners of the main body.

2. The notebook of claim 1, wherein the cover comprises a front cover, a back cover, and a connecting part connected between the front cover and the back cover, and the four corners of the front cover and the back cover are round respectively corresponding to the four round corners of the main body.

3. The notebook of claim 2, wherein each end of the connecting part, the front cover, and the back cover cooperatively form a U-shaped groove.

4. The notebook of claim 2, wherein an L-shaped fastening part extends from the middle of the side of the back cover apart from the connecting part for being fastened to the front cover.

5. The notebook of claim 4, wherein the free end of the fastening part is provided with a magnet, and the fastening part is rotatablely attached to the front cover; the front cover is provided with a magnet corresponding to the magnet at the free end of the fastening part.

6. The notebook of claim 1, wherein the cover is made from materials with metal tactile sensation.

7. The notebook of claim 6, wherein the cover is made from an aluminum foil paper, or an aluminium plating film.

8. The notebook of claim 1, wherein the notebook is flippable upwards.

9. The notebook of claim 8, wherein the width of the notebook from left to right is larger than the length of the notebook from up to down.

10. The notebook of claim 9, wherein the proportion of the notebook between the width thereof and the length thereof is from 4:3 to 16:9.
